(19) United States
(12) Patent Application Publication
(10) Pub. No.: US 2025/0209687 A1
(43) Pub. Date: Jun. 26, 2025

(54) INTERACTION METHOD AND APPARATUS, STORAGE MEDIUM, DEVICE, AND PROGRAM PRODUCT

(71) Applicant: Beijing Zitiao Network Technology Co., Ltd., Beijing (CN)

(72) Inventors: Shuo LIU, Beijing (CN); Chi FANG, Beijing (CN); Jia GUO, Beijing (CN); Xiaolin LI, Beijing (CN); Jingwei LIU, Beijing (CN); Mengqian LIU, Beijing (CN); Rongxuan MU, Beijing (CN)

(21) Appl. No.: 18/991,005

(22) Filed: Dec. 20, 2024

(30) Foreign Application Priority Data
Dec. 21, 2023 (CN) 202311778412.3

(51) Int. Cl. G06T 11/00; A63F 13/52

(52) U.S. Cl. CPC G06T 11/00; A63F 13/52; A63F 2300/8082

(57) ABSTRACT

The present application discloses an interaction method and apparatus, a storage medium, a device, and a program product. The method includes: displaying a virtual object in a virtual reality environment; mapping a real interactor to the virtual reality environment to form a virtual interactor based on a real position of the real interactor; determining an offset between a virtual position and the real position based on an interaction operation between the real interactor and the virtual object in the virtual reality environment; and adjusting the virtual position of the virtual interactor based on the offset to show a position offset state between the virtual position and the real position.

### CROSS-REFERENCE TO RELATED APPLICATIONS

The present application claims priority to and is based on a Chinese application with an application number 202311778412.3 and a filing date of Dec. 21, 2023, the aforementioned application is hereby incorporated by reference in its entirety.

### TECHNICAL FIELD

The present application relates to the field of virtual reality technologies, and in particular, to an interaction method and apparatus, a storage medium, a device, and a program product.

### BACKGROUND

A virtual reality (MR/VR) display system can provide virtual images that can occupy an entire field of view of a user, thereby allowing the user to immerse in a virtual reality environment. Such a display system can present virtual visual and auditory experiences in a very realistic manner, allowing users to feel as if they have immersively entered a new, digital world.

### SUMMARY

In one aspect, an embodiment of the present application provides an interaction method. The method includes: displaying a virtual object in a virtual reality environment; mapping a real interactor to the virtual reality environment to form a virtual interactor, based on a real position of the real interactor; determining an offset between a virtual position and the real position based on an interaction operation between the real interactor and the virtual object in the virtual reality environment; and adjusting the virtual position of the virtual interactor based on the offset to show a position offset state between the virtual position and the real position.

In another aspect, an embodiment of the present application provides an interaction apparatus. The apparatus includes:
a display unit, configured to display a virtual object in a virtual reality environment;
a mapping unit, configured to map a real interactor to the virtual reality environment to form a virtual interactor, based on a real position of the real interactor;
a determination unit, configured to determine an offset between a virtual position and the real position based on an interaction operation between the real interactor and the virtual object in the virtual reality environment; and
an adjustment unit, configured to adjust the virtual position of the virtual interactor based on the offset to show a position offset state between the virtual position and the real position.

In another aspect, an embodiment of the present application provides a computer-readable storage medium. The computer-readable storage medium stores a computer program, the computer program being adapted to be loaded by a processor to execute the interaction method according to any one of the embodiments described above.

In another aspect, an embodiment of the present application provides a terminal device. The terminal device includes a processor and a memory, the memory storing a computer program, and the processor is configured to call the computer program stored in the memory to execute the interaction method according to any one of the embodiments described above.

In another aspect, an embodiment of the present application provides a computer program product, including a computer program, the computer program, when executed by a processor, implementing the interaction method according to any one of the embodiments described above.

### BRIEF DESCRIPTION OF THE DRAWINGS

To describe technical solutions in the embodiments of the present application more clearly, the following briefly introduces accompanying drawings required for describing the embodiments. Apparently, the accompanying drawings in the following description show merely some embodiments of the present application, and those ordinary skilled in the art may still derive other drawings from these accompanying drawings without paying creative efforts.

FIG. 1 is a schematic flowchart of an interaction method according to an embodiment of the present application.

FIG. 2 is a schematic diagram of a first application scenario of the interaction method according to an embodiment of the present application.

FIG. 3 is a schematic diagram of a second application scenario of the interaction method according to an embodiment of the present application.

FIG. 4 is a schematic diagram of a third application scenario of the interaction method according to an embodiment of the present application.

FIG. 5 is a schematic diagram of a fourth application scenario of the interaction method according to an embodiment of the present application.

FIG. 6 is a schematic diagram of a fifth application scenario of the interaction method according to an embodiment of the present application.

FIG. 7 is a schematic diagram of a sixth application scenario of the interaction method according to an embodiment of the present application.

FIG. 8 is a schematic diagram of a seventh application scenario of the interaction method according to an embodiment of the present application.

FIG. 9 is a schematic diagram of an eighth application scenario of the interaction method according to an embodiment of the present application.

FIG. 10 is a schematic diagram of a ninth application scenario of the interaction method according to an embodiment of the present application.

FIG. 11 is a schematic diagram of a tenth application scenario of the interaction method according to an embodiment of the present application.

FIG. 12 is a schematic diagram of an eleventh application scenario of the interaction method according to an embodiment of the present application.

FIG. 13 is a schematic structural diagram of an interaction apparatus according to an embodiment of the present application.

FIG. 14 is a first schematic structural diagram of a terminal device according to an embodiment of the present application.

FIG. 15 is a second schematic structural diagram of a terminal device according to an embodiment of the present application.

### DETAILED DESCRIPTION OF EMBODIMENTS

The following clearly and completely describes the technical solutions in the embodiments of the present application with reference to the accompanying drawings in the embodiments of the present application. Apparently, the described embodiments are some but not all of the embodiments of the present application. All other embodiments obtained by those ordinary skilled in the art based on the embodiments of the present application without paying creative efforts shall fall within the protection scope of the present application.

The embodiments of the present application may be applied to various application scenarios such as Extended Reality (XR), Virtual Reality (VR), Augmented Reality (AR), Mixed Reality (MR), and the like.

First, some of nouns or terms that appear in the process of describing the embodiments are explained as follows:

A virtual scene is a virtual scene displayed (or provided) when an application runs on a terminal or a server. Optionally, the virtual scene is a simulation environment of the real world, or a semi-simulation and semi-fiction virtual environment, or a purely fictitious virtual environment. The virtual scene is any one of a two-dimensional virtual scene and a three-dimensional virtual scene. The virtual environment may be the sky, the land, the ocean, and the like, where the land includes environmental elements such as deserts and cities. The virtual scene is a scene in which a user controls a virtual object to perform a complete game logic or the like.

A virtual object refers to a dynamic object that can be controlled in a virtual scene. Optionally, the dynamic object may be a virtual person, a virtual animal, an anime character, and the like. The virtual object is a character controlled by a player through an input device, or an artificial intelligence (AI) set in a game in virtual environment through training, or a non-player character (NPC) set in a game in virtual scene. Optionally, the virtual object is a virtual character who competes in the virtual scene. Optionally, a quantity of virtual objects in the game in virtual scene is preset, or is dynamically determined based on a quantity of clients that join the game, which is not limited in the embodiments of the present application. In a possible implementation, a user can control the virtual object to move in the virtual scene, for example, control the virtual object to run, jump, crawl, and the like, and can also control the virtual object to fight with another virtual object by using skills, a virtual prop, and the like that are provided by the application. Optionally, the virtual object may also refer to a static object that can be interacted with in the virtual scene, such as a virtual physical object, a virtual control, an interface element, and a virtual prop.

Extended Reality (XR) is a concept including Virtual Reality (VR), Augmented Reality (AR), and Mixed Reality (MR), and represents a technology for connecting a virtual world to a real world to implement an environment in which a user can interact with the environment in real time.

Virtual Reality (VR) is a technology for creating and experiencing a virtual world, and calculating to generate a virtual environment, it is a multi-source information (the virtual reality mentioned herein includes at least visual perception, and may further include auditory perception, tactile perception, motion perception, and even gustatory perception, olfactory perception, and the like), implements fused and interactive simulation of a three-dimensional dynamic view and an entity behavior in the virtual environment, so that a user is immersed in a simulated virtual reality environment, to implement applications in various virtual environments such as maps, games, videos, education, healthcare, simulation, collaborative training, sales, manufacturing assistance, maintenance, and repair.

Augmented Reality (AR) is a technology for adding a virtual element to an image collected by a camera based on camera pose parameters of the camera in the real world (or referred to as a three-dimensional world or an actual world) that are calculated in real time during image collection by the camera. The virtual element includes, but not limited to, an image, a video, and a three-dimensional model. An objective of the AR technology is to superimpose a virtual world on a real world for interaction on a screen.

Mixed Reality (MR) is a simulated setting in which a computer-created sensory input (for example, a virtual object) is integrated with a sensory input from a physical setting or a representation thereof. In some MR settings, the computer-created sensory input may be adapted to changes in the sensory input from the physical setting. In addition, some electronic systems for presenting MR settings can monitor an orientation and/or a position relative to the physical setting, so that virtual objects can interact with real objects (that is, physical elements from the physical setting or representations thereof). For example, the system can monitor motion, so that a virtual plant appears to be stationary relative to a physical building.

Augmented Virtuality (AV): An AV setting refers to a simulated setting in which a computer-created setting or a virtual setting is incorporated with at least one sensory input from a physical setting. One or more sensory inputs from the physical setting may be representations of at least one feature of the physical setting. For example, a virtual object may present a color of a physical element captured by one or more imaging sensors. For another example, the virtual object may present a feature consistent with actual weather conditions in the physical setting, as identified through weather-related imaging sensors and/or online weather data. In another example, an augmented reality forest may have virtual trees and structures, but animals may have features accurately reproduced from images taken of physical animals.

A virtual field of view is an area in a virtual environment that a user can perceive through a lens in a virtual reality device, and a field of view (FOV) of the virtual field of view is used to represent the perceived area.

A virtual reality device is a terminal that implements a virtual reality effect, and is usually provided in the form of glasses, a head mount display (HMD), or contact lenses to implement visual perception and other forms of perception. Certainly, the form implemented by the virtual reality device is not so limited, and may be further miniaturized or enlarged as required.

The virtual reality device described in the embodiments of the present application may include but is not limited to the following types:

A computer-side virtual reality (PCVR) device that performs related calculation and data output of a virtual reality function by using a PC side, and an external PC-side virtual reality device implements the virtual reality effect by using data output by the PC side.

A mobile virtual reality device that supports arranging a mobile terminal (for example, a smart phone) in various manners (for example, a head-mounted display provided with a dedicated card slot) to cause the mobile terminal to perform relevant calculation of a virtual reality function and outputs data to the mobile virtual reality device through a wired or wireless connection to the mobile terminal, for example, a virtual reality video is watched through an APP of the mobile terminal.

An all-in-one virtual reality device that is provided with a processor for performing relevant calculation of a virtual function, and therefore has separate virtual reality input and output functions, does not need to be connected to a PC side or a mobile terminal, and has a high degree of freedom in use.

Users can interact with virtual objects in the virtual reality environment, but because the virtual objects themselves do not exist in the real space, users do not have a tactile sensation when interacting with the virtual objects in the virtual reality environment, which spoils a certain sense of immersion.

In view of this, embodiments of the present application provide an improved interface solution which can visually simulate tactile feedback when a user interacts with a virtual object, thereby enhancing the immersivity of the user.

The following provides detailed descriptions separately. It should be noted that the description sequence of the following embodiments is not used as a limitation on the preferred sequence of the embodiments.

Embodiments of the present application provide an interaction method. The method may be performed by a terminal or a server, or may be performed jointly by the terminal and the server. The embodiments of the present application will be described by taking the interaction method being performed by a terminal device as an example.

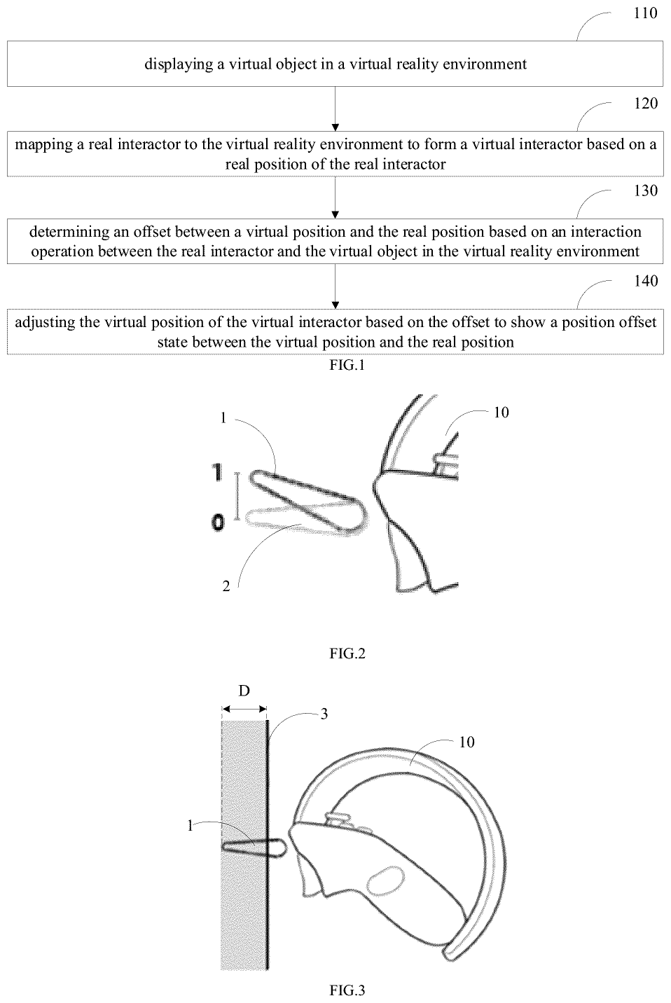

FIG. 1 to FIG. 12 are used for describing the interaction method according to the embodiments of the present application. FIG. 1 is a schematic flowchart of an interaction method according to an embodiment of the present application. FIG. 2 to FIG. 12 are schematic diagrams of application scenarios of the interaction method according to the embodiments of the present application. The method may be applied to a terminal device. The terminal device may be any one of an extended reality device, a virtual reality device, an augmented reality device, and a mixed reality device. The method includes the following steps 110 to 140.

Step 110: Display a virtual object in a virtual reality environment.

For example, a point cloud map of the virtual reality environment may be constructed based on real environment image data collected and processed by a tracking camera and an inertial measurement unit, and the virtual object may be displayed at a set coordinate position in the virtual reality environment according to the coordinate of the point cloud map.

Display of the virtual object is performed in the virtual reality environment. This usually involves creating and displaying a virtual reality environment by using a specific virtual reality technology, such as devices such as a head-mounted display and a handle. In the virtual reality environment, a user can see a virtual image generated by a computer, and obtain visual feedback through a device such as a head-mounted display. When the virtual object is displayed, it is required to ensure that the virtual object can be clearly and accurately presented to the user in the virtual reality environment.

For example, the virtual object may be a virtual interaction interface (or a virtual panel), a virtual physical object, a virtual character, or the like.

Displaying the virtual object in the virtual reality environment means creating and displaying one or more virtual objects in the virtual reality environment. These virtual objects may be virtual interfaces, objects, characters, or any other form of virtual entities. These virtual objects may provide various interactive experiences in the virtual reality environment, for example, interacting with the user, providing information, simulating physical phenomena in the real world, or the like. A specific implementation of displaying the virtual object in the virtual reality environment may be selected as required. For example, a three-dimensional virtual physical object or scene may be created by using a three-dimensional modeling technology, or a two-dimensional image may be converted into a three-dimensional virtual physical object or scene by using an image rendering technology. When the virtual object is created, it is required to consider how the user can interact with the virtual object, for example, interact by inputting an interaction instruction through an interactor, hand gestures, voice recognition, or other technologies.

Displaying the virtual object in the virtual reality environment is an important part of the virtual reality technology, which can enable the user to feel various experiences in the virtual reality environment more realistically, thereby enhancing the immersivity and experience of the user. In addition, by interacting with the virtual object, the user can perform operation and interaction more naturally and intuitively, thereby better using the virtual reality technology.

Step 120: Map a real interactor to the virtual reality environment to form a virtual interactor, based on a real position of the real interactor.

Mapping the real interactor to the virtual reality environment to form the virtual interactor based on the real position of the real interactor means converting position information of the real interactor into virtual position information in the virtual reality environment, to create a corresponding virtual interactor in the virtual reality environment.

Specifically, “mapping the real interactor to the virtual reality environment to form the virtual interactor” may be implemented by the following steps S121 to S123.

S121: Obtain real position information of the real interactor. The real position information of the real interactor, for example, information such as three-dimensional coordinates and a posture in space, etc., may be obtained by using a sensor such as a position sensor, a camera, an inertial sensor, or the like.

S122: Convert the real position information into virtual position information. The obtained position information of the real interactor is converted into virtual position information in the virtual reality environment. This conversion process may be implemented by using technologies such as coordinate transformation, a transformation matrix, etc., Coordinate transformation is a method of converting a point in a coordinate system from one form to another. In virtual reality technology, coordinate transformation may be used to convert position information of a real interactor from a real coordinate system to a virtual coordinate system in a virtual reality environment. A transformation matrix is a commonly used tool that can be used to describe a transformation relationship between different coordinate systems. By using the transformation matrix, the position information of the real interactor may be mapped from the real coordinate system to the virtual coordinate system, to obtain the virtual position information. In addition to coordinate transformation and the transformation matrix, other technologies may also be used to implement conversion from the real position information to the virtual position information. For example, an interpolation algorithm may be used to perform smooth transition between the real position and the virtual position. In addition, a sensor data fusion technology may be used to improve accuracy and stability of the position information.

S123: Create the virtual interactor in the virtual reality environment. A corresponding virtual interactor is created in the virtual reality environment based on the converted virtual position information. The virtual interactor may be a virtual physical object, a character, or any other form of virtual entity that is similar to the real interactor. For example, the real interactor may include any one of a user's hand, a handle, a controller, a stylus, and the like. The corresponding virtual interactor that is generated may be a virtual hand, a virtual handle, a virtual controller, a virtual pen, a virtual tool, or the like.

In step 120, the real interactor is mapped to the virtual reality environment to form the virtual interactor, so that when a user performs an interaction operation with the virtual object in the virtual reality environment, the user can obtain more realistic and natural tactile feedback. In addition, the mapping process may also be used to implement positioning and navigation of the user in the virtual reality environment, thereby improving the immersivity and experience of the user.

Step 130: Determine an offset between a virtual position and a real position based on an interaction operation between the real interactor and the virtual object in the virtual reality environment.

Determining an offset between a virtual position and a real position based on an interaction operation between the real interactor and the virtual object in the virtual reality environment means determining the offset between the virtual position and the real position by monitoring an operation of the real interactor in the virtual reality environment and an interaction with the virtual object. The offset may represent a position offset state between the virtual interactor and the real interactor.

In some embodiments, determining an offset between a virtual position and a real position based on an interaction operation between the real interactor and the virtual object in the virtual reality environment comprises:
determining, based on the interaction operation between the real interactor and the virtual object in the virtual reality environment, a resistance of the virtual object relative to the virtual interactor; and
determining the offset between the virtual position and the real position based on the resistance.

The resistance may represent a degree of obstruction of the virtual object to movement of the virtual interactor, or may represent an interaction force between the virtual object and the virtual interactor.

Specifically, the resistance of the virtual object relative to the virtual interactor may be measured by monitoring the interaction operation between the real interactor and the virtual object in the virtual reality environment, for example, operations such as sliding, dragging, pushing and pulling, holding, pressing, and lifting. The resistance may be a numerical value or a vector, representing a magnitude and a direction of a force applied by the virtual object to the virtual interactor.

Then, the offset between the virtual position and the real position can be determined based on the resistance. The offset represents a position offset state of the virtual interactor relative to the real interactor in the virtual reality environment. Through the offset, a mapping relationship from the real interactor to the virtual interactor may be implemented, thereby enhancing the immersivity of the user. In addition, the offset may also enable the user to have a boundary sensation when interacting with the virtual object in the virtual reality environment, to make up for the lack of tactile sensation and provide force feedback. For example, when the user interacts with the virtual object, for example, drags a virtual physical object, the user may feel the resistance effect of the virtual physical object to the virtual interactor. The resistance may represent a physical attribute of the virtual physical object such as a size, a shape, a weight, etc., and an interaction relationship between the virtual physical object and the virtual interactor. By measuring the resistance, the offset between the virtual position and the real position may be determined, to generate a boundary sensation, allowing the user to feel his/her presence in the virtual reality environment. In addition, the offset may also provide force feedback to the user. For example, when the user forcefully drags a virtual physical object, the user may feel a large resistance effect of the virtual physical object to the virtual interactor, so that the user knows that he/she is forcefully dragging the object. Such force feedback can enhance user' perception and understanding of the interaction operation in the virtual reality environment, thereby enhancing the immersivity and experience of the user.

By determining the offset between the virtual position and the real position and combining the resistance measurement, physical phenomena in the virtual reality environment can be more realistically simulated. For example, when the user drags a virtual physical object in the virtual reality environment, the user may feel a resistance effect of the virtual physical object to the virtual interactor, thereby more realistically feeling his/her presence in the virtual environment. This resistance-based offset determination method may also be used to implement finer and more accurate operations and interactions, for example, in application scenarios such as performing a simulated surgery, designing and manufacturing an object and so on in the virtual reality environment.

In some embodiments, determining, based on the interaction operation between the real interactor and the virtual object in the virtual reality environment, a resistance of the virtual object relative to the virtual interactor comprises:
obtaining a motion direction, a depth, and an acceleration that are generated when the real interactor performs an interaction operation with the virtual object in the virtual reality environment, the depth is a depth value of the real interactor relative to a virtual surface of the virtual object, and the acceleration is an acceleration of the real interactor moving relative to the virtual object; and
determining the resistance of the virtual object relative to the virtual interactor based on the motion direction, the depth, and the acceleration.

The motion direction refers to a direction in which the real interactor moves relative to the virtual object in the virtual reality environment. The motion direction may be used to determine a resistance direction of the virtual object relative to the virtual interactor. For example, if the real interactor moves to the right, and the resistance of the virtual object to the virtual interactor is to the left, the resistance effect may be felt. The depth refers to a depth value of the real interactor relative to the virtual surface of the virtual object. The depth may be used to determine a magnitude of resistance of the virtual object relative to the virtual interactor. For example, if the real interactor goes deep into an interior of the virtual object, a greater resistance may be felt. The acceleration refers to an acceleration of the real interactor moving relative to the virtual object. The acceleration may be used to determine a resistance change of the virtual object relative to the virtual interactor. For example, if the real interactor moves acceleratedly, a gradually increasing resistance may be felt; or if the real interactor moves deacceleratedly, a gradually decreasing resistance may be felt.

The resistance of the virtual object relative to the virtual interactor may be determined based on the motion direction, the depth, and the acceleration. The resistance may represent a magnitude and a direction of a force applied by the virtual object to the virtual interactor, thereby implementing a mapping relationship from the real interactor to the virtual interactor and enhancing the immersivity of the user. In addition, by means of the resistance, physical phenomena in the virtual reality environment, such as object collision, friction, heavy object lifting, and sliding on an interface, may also be more realistically simulated.

In some embodiments, the resistance comprises a resistance value and a resistance direction, and determining the resistance of the virtual object relative to the virtual interactor based on the motion direction, the depth, and the acceleration comprises:
determining the resistance value of the virtual object relative to the virtual interactor based on the depth and the acceleration, wherein the depth is in a direct proportion to the resistance value, and the acceleration is in a direct proportion to the resistance value; and
determining the resistance direction of the virtual object relative to the virtual interactor based on the motion direction of the real interactor, the resistance direction is opposite to the motion direction.

Determining the resistance of the virtual object relative to the virtual interactor comprises determining the resistance value and the resistance direction.

The resistance value is determined based on the depth and the acceleration. The depth is in a direct proportion to the resistance value, which means that when the depth increases, the resistance value also increases. For example, if the user makes the real interactor deep into an interior of the virtual object, the resistance value of the virtual object to the virtual interactor is also greater. The acceleration is in a direct proportion to the resistance value, which means that when the acceleration increases, the resistance value also increases. For example, if the user moves the real interactor at a higher speed, the resistance value of the virtual object to the virtual interactor is also greater.

For example, the resistance value may range from 0 to 1, and the value of 0 to 1 is a relative value. The value 0 may represent a state of starting adjustment of the virtual interactor, and the value 1 may represent a state of ending adjustment of the virtual interactor.

For example, as shown in FIG. 2, a user immersively experiences a virtual reality environment based on a virtual reality device 10. During an interaction operation between a real interactor 1 (such as a baton or a handle) and a virtual object in the virtual reality environment, a larger resistance value indicates a larger visual deformation amplitude of a virtual interactor 2 (such as a virtual pointer) relative to the real interactor 1 (such as a baton or a handle). The visual deformation amplitude may be used to represent a posture offset amplitude in an offset.

The resistance value of the virtual object relative to the virtual interactor is determined based on a product of the depth and the acceleration, that is, the resistance value=the depth*the acceleration. When a sum of the depth and the acceleration is greater than 1, the resistance value is 1.

For example, if the resistance value may be 0 to 1, and if the posture offset amplitude in the offset is determined based on the resistance value, the posture offset amplitude of the virtual interactor 2 (such as a virtual pointer) ranges from 0 to 1.

The depth parameter corresponds to the resistance value, and a deeper depth indicates a larger resistance value. For example, the depth value may range from 0 to 1, and the value of 0 to 1 is a relative value.

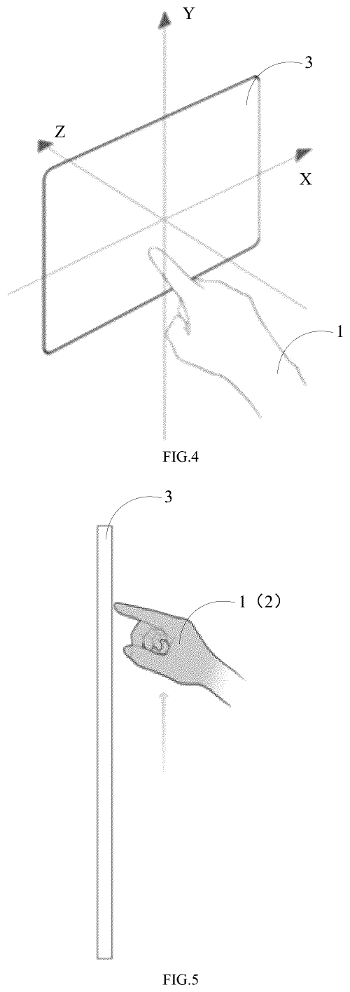

For example, as shown in FIG. 3, when the real interactor 1 penetrates a virtual surface of a virtual object 3 (such as a virtual panel), there is a depth value D of the real interactor 1 relative to the virtual surface of the virtual object 3.

For example, a larger acceleration indicates a larger resistance value. The acceleration value may range from 0 to 1, and the value of 0 to 1 is a relative value.

The resistance direction is determined based on the motion direction of the real interactor. If the real interactor moves upward, the resistance direction of the virtual object relative to the virtual interactor is downward. This relationship between the resistance direction opposite to the motion direction may be used to implement a mapping relationship from the real interactor to the virtual interactor, thereby enhancing the immersivity of the user. For example, when the user pushes a virtual physical object to the right, the user may feel a resistance of the virtual physical object to the virtual interactor to the left, thereby more realistically feeling his/her presence in the virtual reality environment.

By determining the resistance value and the resistance direction of the virtual object relative to the virtual interactor, physical phenomena in the virtual reality environment can be more realistically simulated. For example, when the user pushes a virtual physical object in the virtual reality environment, the user may feel a resistance of the virtual physical object to the virtual interactor, thereby more realistically feeling his/her presence in the virtual reality environment.

As shown in FIG. 4 to FIG. 7, for example, the real interactor 1 is a physical hand, the virtual interactor 2 is a virtual hand, and the virtual object 3 is a virtual panel. When the virtual interactor 2 (such as a virtual hand) interacts with the virtual object 3 (such as a virtual panel) in the virtual reality environment, a damping effect is applied to the virtual interactor 2 (such as a virtual hand). For example, the damping effect is specifically manifested as a resistance or a friction. For example, a deeper depth indicates a larger resistance.

In a coordinate system shown in FIG. 4, an X axis represents a lateral position, a Y axis represents a vertical position, and a Z axis represents a depth position. It is shown in the figure that the real interactor 1 (such as the physical hand) performs an interaction operation with the virtual object 3 (such as the virtual panel).

When the real interactor 1 (such as the physical hand) performs a sliding operation on the virtual object 3 (such as the virtual panel), a resistance (that is, friction) when the virtual hand slides can be given based on a sliding depth (that is, a depth of over touch) of the real interactor 1 (such as the physical hand), and the resistance increases as the sliding depth increases. This resistance may affect an offset parameter of the virtual interactor 2 (such as the virtual hand).

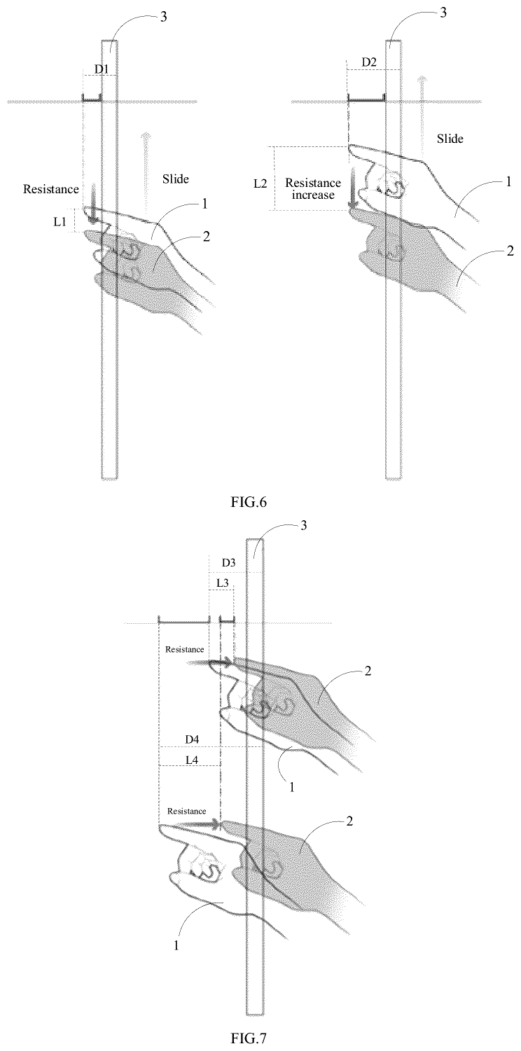

As shown in FIG. 5, when the real interactor 1 (such as the physical hand) does not penetrate the virtual object 3 (such as the virtual panel), the virtual interactor 2 (such as the virtual hand) and the real interactor 1 (such as the physical hand) are not offset in their motion positions on the X axis and the Y axis. This means that only after the physical hand penetrates the virtual panel, the virtual hand may be offset on the X axis and the Y axis. The offset may be determined by a sliding depth of the physical hand and a resistance of the virtual panel jointly.

As shown in FIG. 6, it is illustrated that when the real interactor 1 (such as the physical hand) penetrates the virtual object 3 (such as the virtual panel), a position of the virtual interactor 2 (such as the virtual hand) is offset relative to the real interactor 1 (such as the physical hand). After the real interactor 1 (such as the physical hand) penetrates the virtual object 3 (such as the virtual panel), the farther the penetration distance of the real interactor 1 (such as the physical hand) is (that is, a depth distance D2 on the Z axis is greater than a depth distance D1), the larger the resistance applied to the virtual interactor 2 (such as the virtual hand) is, and the larger the position offset of the virtual interactor 2 (such as the virtual hand) relative to the real interactor 1 (such as the physical hand) on the Y axis (that is, an offset L2 is greater than an offset L1) is. Compared with the left diagram in FIG. 6, the resistance in the right diagram in FIG. 6 increases, and a corresponding position offset between the virtual interactor 2 (such as the virtual hand) and the real interactor 1 (such as the physical hand) also increases. The resistance may increase as the penetration distance of the real interactor 1 (such as the physical hand) increases, thereby affecting the offset parameter of the virtual interactor 2 (such as the virtual hand).

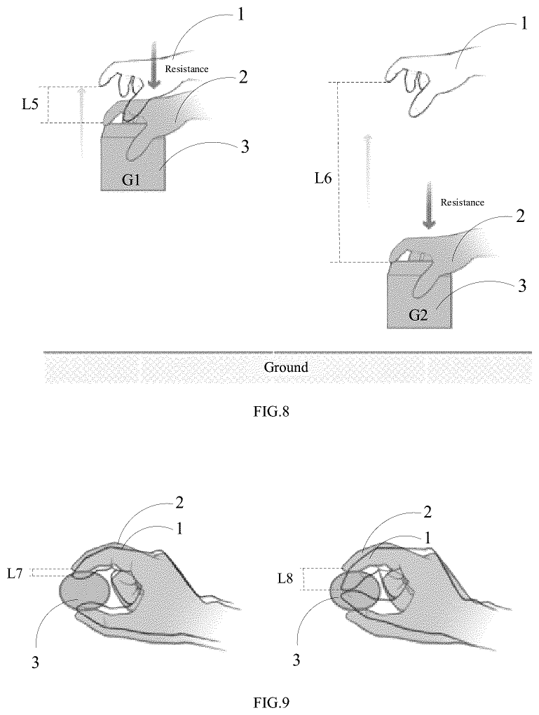

As shown in FIG. 7, when the user performs a click operation on the virtual object 3 (such as the virtual panel) by using the real interactor 1 (such as the physical hand), the system applies a resistance for semi-penetration of the virtual interactor 2 (such as the virtual hand) based on a click depth (that is, a depth of over touch) of the real interactor 1 (such as the physical hand) on the virtual object 3 (such as the virtual panel). The resistance increases as the click depth increases. Such resistance may also affect the offset parameter of the virtual interactor 2 (such as the virtual hand). FIG. 7 illustrates that after the real interactor 1 (such as the physical hand) penetrates the virtual object 3 (such as the virtual panel), the farther the penetration distance of the real interactor 1 (such as the physical hand) is (that is, a depth distance D4 on the Z axis is greater than a depth distance D3), the larger the resistance applied to the virtual interactor 2 (such as the virtual hand) is, and the larger the position offset of the virtual interactor 2 (such as the virtual hand) relative to the real interactor 1 (such as the physical hand) on the Z axis is (that is, an offset L4 is greater than an offset L3).

In some embodiments, determining the resistance value of the virtual object relative to the virtual interactor based on the depth and the acceleration further comprises:
obtaining a physical characteristic parameter of the virtual object, the physical characteristic parameter includes at least one of mass, material hardness, and volume; and
determining the resistance value of the virtual object relative to the virtual interactor based on the physical characteristic parameter of the virtual object, the depth, and the acceleration, a parameter value of the physical characteristic parameter is in a direct proportion to the resistance value.

For example, determining the resistance value of the virtual object relative to the virtual interactor further comprises obtaining a physical characteristic parameter of the virtual object. The physical characteristic parameter of the virtual object includes at least one of mass, material hardness, and volume. These parameters may be used to describe physical properties and characteristics of the virtual object in the virtual reality environment, for example, the mass may represent a size and a weight of the virtual object, the material hardness may represent a hardness and an elasticity of the virtual object, and the volume may represent a shape and a size of the virtual object.

Then, the resistance value of the virtual object relative to the virtual interactor may be determined based on the physical characteristic parameter of the virtual object, the depth, and the acceleration. For example, if the mass of the virtual object is relatively large, the resistance of the virtual object to the virtual interactor also increases accordingly. If the material hardness is high, the resistance of the virtual object to the virtual interactor also increases. If the volume is large, the resistance of the virtual object to the virtual interactor also increases. The parameter values of such physical characteristic parameters are in a direct proportion to the resistance value.

By obtaining the physical characteristic parameter of the virtual object and considering it in the process of determining the resistance value, physical phenomena in the virtual reality environment can be more accurately simulated.

For example, if a user pushes a virtual physical object with a large mass in the virtual reality environment, he/she may feel a greater resistance. Similarly, if the material hardness of the virtual physical object is high, the user may need to spend more force to push it. By considering the physical characteristic parameter, the immersivity and experience of the user can be improved.

For example, as shown in FIG. 8, it is illustrated that a user grasps two virtual objects 3 (such as virtual physical objects) simultaneously from the ground based on a real interactor 1 (such as a physical hand) in a virtual reality environment. When the real interactor 1 (such as the physical hand) grasps the virtual objects 3 (such as the virtual physical objects) to a same height, due to different mass parameters of the virtual objects 3 (such as the virtual physical objects), position offsets or resistances applied to a virtual interactor 2 (such as a virtual hand) are also different, thereby reflecting weights of the virtual objects 3 (such as the virtual physical objects). A virtual object 3 (such as a virtual physical object) with a larger mass (the mass G2 is greater than the mass G1) generates a greater resistance, and a corresponding position offset between the virtual interactor 2 (such as the virtual hand) and the real interactor 1 (such as the physical hand) is also larger (that is, an offset L6 is greater than an offset L5).

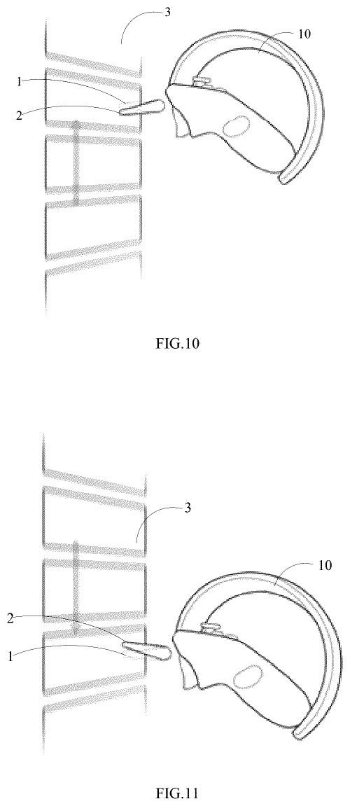

For example, as shown in FIG. 9, it is illustrated that when a user squeezes two virtual objects 3 (such as virtual balls) at the same time based on a real interactor 1 (such as a physical hand) in a virtual reality environment, a material hardness of the virtual objects 3 (such as the virtual balls) is reflected by a position offset between a virtual interactor 2 (such as a virtual hand) and the real interactor 1 (such as the physical hand). For example, an offset L7 in the left diagram is smaller, and an offset L8 in the right diagram is larger, thereby reflecting that the material of the virtual object 3 (such as the virtual ball) in the right diagram is harder.

In addition, by obtaining the physical characteristic parameter of the virtual object and considering it in the process of determining the resistance value, finer and more accurate operations and interactions may also be implemented. For example, when performing a simulated surgery in the virtual reality environment, a doctor may need to more accurately control a motion and a force of a surgical instrument. By considering the physical characteristic parameter of the virtual object, the resistance and the reaction force during the surgery process can be better simulated, thereby providing a more realistic operational sensation and tactile feedback. This physical characteristic-based offset determination method may also be used to implement application scenarios such as object design and manufacturing, for example, helping engineers better simulate and analyze performance and behaviors of a product.

In some embodiments, the offset comprises a displacement distance and a displacement direction, and determining the offset between the virtual position and the real position based on the resistance comprises:
determining the displacement distance of the offset based on the resistance value, the resistance value being in a direct proportion to the displacement distance; and
determining the displacement direction of the offset based on the motion direction of the real interactor, the motion direction being the same as the displacement direction.

When the real interactor interacts with the virtual object, the system determines an offset of the virtual interactor based on an interaction force (that is, the resistance) between the real interactor and the virtual object. The offset comprises the displacement distance and the displacement direction. The displacement distance refers to an offset distance of the virtual interactor relative to the real interactor, and the displacement direction refers to a position offset direction of the virtual interactor.

The system may determine the displacement distance of the offset based on the resistance value. When the resistance value is smaller, the displacement distance is also smaller; and as shown in FIG. 6 to FIG. 9, when the resistance value is larger, the displacement distance L of the offset also increases accordingly. This relationship may be used to simulate physical properties and behaviors of an object in the virtual reality environment. For example, when the users gently touch a virtual physical object, they may only feel a small position offset; and when they press the virtual physical object hard, the object may generate a larger position offset.

The system may also determine the displacement direction of the offset based on the motion direction of the real interactor. The motion direction is the same as the displacement direction, which means that when the real interactor moves to the right, the virtual interactor also shifts to the right. This mechanism may be used to implement a mapping relationship from the real interactor to the virtual interactor, thereby enhancing the immersivity and experience of the user. For example, when performing a simulated surgery in the virtual reality environment, doctors may use a real interactor to operate a virtual surgical instrument. When they move the surgical instrument to the right, the virtual surgical instrument also shifts to the right, thereby providing a more realistic operational sensation and tactile feedback.

In some embodiments, the offset further comprises a posture offset amplitude and a posture offset direction, and determining the offset between the virtual position and the real position based on the resistance comprises:
determining the posture offset amplitude of the offset based on the resistance value; and
determining the posture offset direction of the offset based on the resistance direction, the resistance direction being the same as the posture offset direction.

In some embodiments, the determining the posture offset amplitude of the offset based on the resistance value comprises:
when the resistance value is less than a second resistance threshold, determining the posture offset amplitude of the offset based on the resistance value, the resistance value being in a direct proportion to the posture offset amplitude; and
when the resistance value is greater than or equal to the second resistance threshold, determining, based on the second resistance threshold, the posture offset amplitude of the offset to remain unchanged.

For example, to further enhance the fidelity and naturalness of virtual interaction, the definition of offset may be extended to a posture offset amplitude and a posture offset direction.

The posture offset amplitude refers to a degree of deviation of the virtual interactor from an original posture during the interaction process. The offset amplitude may be an angle, a distance, or some other forms of measures, depending on a specific application scenario and requirement. For example, in virtual pointer interaction, the posture offset amplitude may be defined as an angle or a distance by which the pointer deviates from an original position. When a user interacts with the virtual object, the system determines the posture offset amplitude of the virtual interactor based on an interaction force (that is, the resistance) between the real interactor and the virtual object.

For example, a process of determining the posture offset amplitude based on the resistance value may be classified into two cases. When the resistance value is less than a preset second resistance threshold, the posture offset amplitude is in a direct proportion to the resistance value. In other words, as the resistance increases, the posture offset amplitude also increases accordingly. This relationship may simulate a displacement effect of an object when an external force is applied to the object, thereby enhancing the fidelity and naturalness of virtual interaction. When the resistance value is greater than or equal to the second resistance threshold, the posture offset amplitude remains unchanged, to avoid excessive posture offset causing distortion of the virtual reality environment. This design is to maintain the stability and the fidelity of the virtual reality environment, so that the user can perform operation and interaction in a relatively real environment.

The posture offset direction refers to a direction in which a posture of the virtual interactor deviates from an original posture. The posture offset direction may be the same as the resistance direction. Because the resistance direction is opposite to the motion direction of the real interactor, the posture offset direction is a direction opposite to the motion direction of the real interactor. For example, as shown in FIG. 10, when the user slides upward while holding the real interactor 1 (such as a handle), a downward resistance is generated, and the virtual interactor 2 (such as a virtual pointer) shifts downward. As shown in FIG. 11, when the user slides downward while holding the real interactor 1 (such as a handle), an upward resistance is generated, and the virtual interactor 2 (such as a virtual pointer) shifts upward. Such design of the posture offset direction being opposite to the motion direction of the real interactor can further enhance the fidelity and the naturalness of virtual interaction.

In conclusion, the posture offset of the virtual interactor may be determined from the resistance value and the resistance direction combinedly, to implement a more realistic and natural virtual reality experience. Such technique can enhance the immersivity and experience of the user, making the virtual reality environment more vivid and perceptive. In addition, the fidelity and naturalness of the virtual interaction can be further enhanced by precisely controlling the posture offset amplitude and delicately processing the posture offset direction, to provide a more real and vivid virtual reality experience for the user.

When the virtual interactor (such as a virtual hand) interacts with the virtual object (such as a virtual panel) in the virtual reality environment, a damping effect is applied to the virtual interactor (such as the virtual hand). For example, the damping effect is specifically manifested as a resistance or a friction. For example, the deeper the depth is, the larger the resistance is.

For example, the damping effect may be determined based on a formula of a drag damping curve, and the damping effect may be used to represent a relationship between an actual depth of the real interactor and a depth of the virtual interactor after offset in an interaction event. The formula is as follows:

$$y = ( 1 - \frac{1}{\frac{cx}{d} + 1} ) d ;$$

where x represents the actual depth of the real interactor; y represents the depth of the virtual interactor after offset; c represents a damping ratio, and the larger c is, the smaller the damping is, and the smaller c is, the larger the damping is; and d represents a distance that the virtual interactor can be offset.

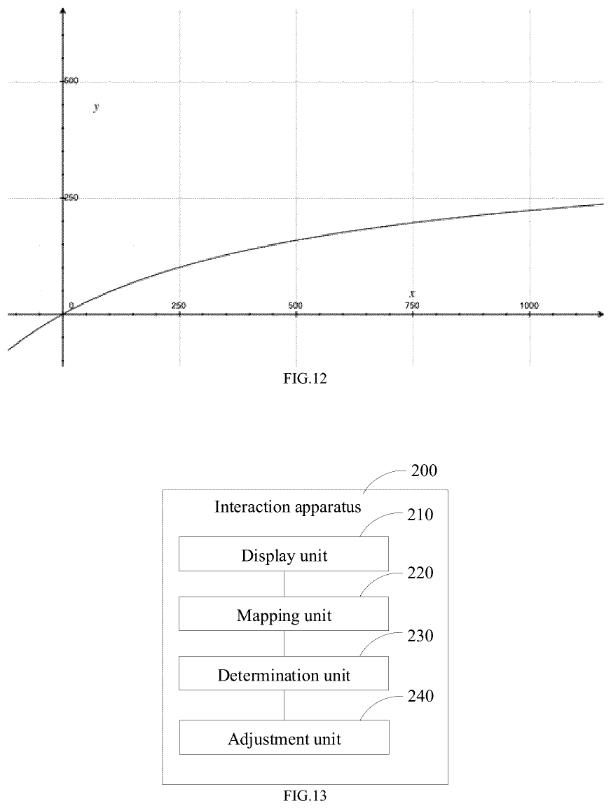

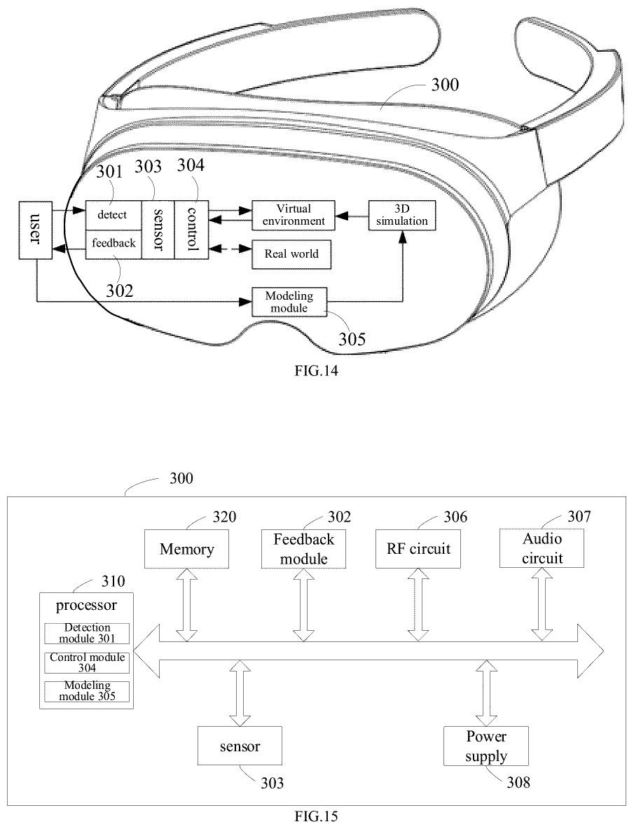

For example, as shown in FIG. 13, a function image of the drag damping curve with c=0.55 and d=375 is illustrated.

Step 140: Adjust the virtual position of the virtual interactor based on the offset, to show a position offset state between the virtual position and the real position.

For example, the virtual position of the virtual interactor is adjusted based on the offset, to show an offset state between the virtual position and the real position. In this process, a plurality of factors such as a displacement distance, a displacement direction, a posture offset amplitude, and a posture offset direction in the offset are comprehensively considered, to ensure that position adjustment of the virtual interactor is more accurate and realistic. A more realistic and natural virtual reality experience may be implemented by determining the virtual position of the virtual interactor from these offset factors combinedly.

Specifically, when the user moves the real interactor in the virtual reality environment, the system adjusts the virtual position of the virtual interactor based on a position and a posture of the real interactor, so that a realistic correspondence between the virtual interactor and the real interactor can be maintained. In this way, an operation of the user in the virtual reality environment becomes more intuitive and natural, thereby enhancing the immersivity and experience of the user.

In addition, the stability and the fidelity of the virtual reality environment are also fully considered. By adding an offset to the virtual position of the virtual interactor, a displacement effect of the virtual object when an external force is applied to the virtual object may be simulated, thereby enhancing the fidelity and naturalness of virtual interaction. The offset may not only enable the user to have a boundary sensation when interacting with the virtual object in the virtual reality environment, but also make up for the lack of tactile sensation and provide force feedback to the user. In this way, the tactile feedback may be simulated visually, thereby further enhancing the immersivity of the user.

Specifically, when the user interacts with the virtual object based on the real interactor, the system adjusts the virtual position of the virtual interactor based on the resistance of the virtual object relative to the virtual interactor and the motion direction of the real interactor, so that the user feels force feedback similar to that in the real world. The force feedback may not only enhance the user's perception of the virtual object, but also improve the trust and satisfaction of the user with the virtual reality environment.

In conclusion, when the user interacts with the virtual object based on the real interactor, no peripheral device (for example, a haptic glove) is needed, but an offset may be added to the virtual position of the virtual interactor. The offset may also enable the user to have a boundary sensation when interacting with the virtual object in the virtual reality environment, to make up for the lack of tactile sensation and provide force feedback. The virtual position of the virtual interactor may be adjusted by comprehensively considering a plurality of offset factors such as the displacement distance, the displacement direction, the posture offset amplitude, and the posture offset direction, to implement a more realistic, natural, and force-feedback virtual reality experience. Such technique may not only enhance the immersivity and experience of the user, but also improve the stability and the fidelity of the virtual reality environment, thereby bringing a richer and more vivid virtual reality experience to the user.

In some embodiments, adjusting the virtual position of the virtual interactor based on the offset comprises:
when the resistance value is less than a first resistance threshold, changing the virtual position of the virtual interactor based on the offset and a position change of the real interactor; and
when the resistance value is greater than or equal to the first resistance threshold, controlling the virtual position of the virtual interactor to remain unchanged in the virtual reality environment.

When the resistance value is less than the first resistance threshold, the virtual position of the virtual interactor is changed based on the offset and the position change of the real interactor. This design is to implement a more natural and realistic interactive experience in the virtual reality environment. When the resistance value is less than the first resistance threshold, which means that the user operates the real interactor with a small force, the virtual position of the virtual interactor may be adjusted based on the offset and the position change of the real interactor, to more realistically simulate a motion state of the virtual interactor in the real world. This design may make a motion of the virtual interactor more natural and smoother when the virtual interactor is subjected to a small resistance.

When the resistance value is greater than or equal to the first resistance threshold, the user operates the real interactor with a large force, a large sliding distance, or a large click depth. In this case, to prevent the virtual interactor from generating an unnatural motion in the virtual reality environment, the virtual position of the virtual interactor may be controlled to remain unchanged in the virtual reality environment. This means that when the resistance reaches a certain threshold, the position of the virtual interactor is no longer adjusted based on the offset and the position change of the real interactor, but remains unchanged. This design can avoid an unnatural motion state of the user when operating the virtual interactor, and can also avoid an interaction distortion or instability caused by an excessive resistance.

As shown in FIG. 7, when the user performs a click operation on the virtual object 3 (such as the virtual panel) by using the real interactor 1 (such as the physical hand), the system gives a resistance value for semi-penetration to the virtual interactor 2 (such as the virtual hand) based on a click depth (that is, a depth of over touch) of the real interactor 1 (such as the physical hand) on the virtual object 3 (such as the virtual panel). As shown in the lower diagram in FIG. 7, when the resistance value reaches or exceeds the first resistance threshold, the virtual position of the virtual interactor 2 (such as the virtual hand) remains unchanged, so that a distortion or instability caused by excessive force may be avoided. However, as the real interactor 1 (such as the physical hand) penetrates farther (that is, a depth distance D4 is greater than a depth distance D3 on the Z axis), a larger resistance is given to the virtual interactor 2 (such as the virtual hand), and a position offset of the virtual interactor 2 (such as the virtual hand) relative to the real interactor 1 (such as the physical hand) on the Z axis is larger (that is, an offset L4 is greater than an offset L3). However, when the real interactor 1 (such as the physical hand) penetrates farther and farther, the virtual position of the virtual interactor 2 (such as the virtual hand) remains unchanged, so as to visually remind the user that an offset of the virtual interactor 2 (such as the virtual hand) has reached a limit, and an operation of the user to continue to move the real interactor 1 (such as the physical hand) is invalid, to prompt the user to re-adjust the position and the posture of the real interactor 1 (such as the physical hand).

In addition, this design may also achieve different interaction effects based on different resistance thresholds. For example, when the resistance value reaches a third resistance threshold, a specific interaction event or effect, for example, a virtual object is enlarged or reduced, or a color of the virtual object is changed, may be triggered. This design can enhance the interactivity and the interestingness of the virtual reality environment, allowing the user to obtain richer and more vivid experiences in the virtual reality environment.

A more natural and realistic virtual reality interactive experience may be implemented by adjusting the virtual position of the virtual interactor based on different resistance values. This design not only considers an operational sensation of the user in the virtual reality environment, but also enhances the stability and the fidelity of the virtual reality environment, ensuring that the user obtains higher-quality and more vivid virtual reality experiences.

In some embodiments, the method further comprises:
determining a color attribute parameter of the virtual interactor based on the resistance, the color attribute parameter comprising at least one of a hue, a saturation, and a lightness; and
adjusting a display color of the virtual interactor based on the color attribute parameter when the virtual position of the virtual interactor is adjusted based on the offset.

In the embodiments of this application, the virtual position of the virtual interactor is adjusted based on the offset, and further the color attribute parameter of the virtual interactor is determined based on the resistance, and when the virtual position is adjusted, the display color of the virtual interactor is adjusted based on the color attribute parameter.

The system may determine the color attribute parameter of the virtual interactor based on a magnitude, a direction, and other possible attributes of the resistance. The color attribute parameter may include at least one of a hue, a saturation, and a lightness. The hue determines a basic color type, such as red, green, and blue; the saturation reflects a purity or an intensity of a color; and the lightness represents a lightness or a darkness degree of the color. These color attribute parameters may be calculated and set based on different attributes of the resistance. The design of this feature is to convert a change of the resistance into a change of the color attribute parameter, to implement color adjustment of the virtual interactor. This design may allow the virtual interactor to present different colors when subjected to different resistances, making the virtual reality environment more vivid, realistic, and perceptive.

For example, when the resistance is large, the system may set a color of the virtual interactor to a darker or deeper hue, to simulate a color change of a virtual object interacting with the virtual interactor when the virtual object is subjected to a large pressure; and when the resistance is small, the system may set the color of the virtual interactor to a brighter or lighter hue, to simulate a color change of the virtual object when the virtual object is subjected to a small pressure. For example, a magnitude of the resistance may affect the lightness or the saturation of the virtual interactor. When the resistance is greater, the lightness of the virtual interactor may be adjusted from dark to bright, or the saturation may be increased, to intuitively feedback a force applied to the virtual interactor. Similarly, the direction of the resistance may also affect the lightness or another color attribute of the virtual interactor, to make the feedback richer and more delicate.

While adjusting the virtual position of the virtual interactor based on the offset, the system adjusts the display color of the virtual interactor based on the color attribute parameter that have been already calculated. In this way, while viewing a position change of the virtual interactor, the user can also perceive operation feedback through a color change, thereby enhancing the immersivity and naturalness of the virtual reality experience.

This design not only makes the virtual reality environment more vivid and perceptive, but also provides a novel and visual feedback manner. The user can learn an operation state and effect of the user in the virtual reality environment more intuitively by observing a color change of the virtual interactor, which undoubtedly enhances the interactivity and the user experience of the virtual reality system.

All the foregoing technical solutions may be combined in any manner to form optional embodiments of the present application, which will not be described again one by one here.

In the embodiments of the present application, a virtual object is displayed in a virtual reality environment; a real interactor is mapped to the virtual reality environment based on a real position of the real interactor to form a virtual interactor; an offset between a virtual position and the real position is determined based on an interaction operation between the real interactor and the virtual object in the virtual reality environment; and the virtual position of the virtual interactor is adjusted based on the offset, to show a position offset state between the virtual position and the real position. In the embodiments of the present application, when the user interacts with the virtual object based on the real interactor, an offset may be added to the virtual position of the virtual interactor, to offset the virtual position of the virtual interactor for the user in the virtual reality environment, to simulate tactile feedback visually, thereby enhancing the immersivity of the user.

To facilitate better implementation of the interaction method in the embodiments of the present application, the embodiments of the present application further provide an interaction apparatus. Refer to FIG. 13. FIG. 13 is a schematic structural diagram of an interaction apparatus according to an embodiment of this application. The interaction apparatus 200 may include:
a display unit 210, configured to display a virtual object in a virtual reality environment;
a mapping unit 220, configured to map a real interactor to the virtual reality environment to form a virtual interactor, based on a real position of the real interactor;
a determination unit 230, configured to determine an offset between a virtual position and the real position based on an interaction operation between the real interactor and the virtual object in the virtual reality environment; and
an adjustment unit 240, configured to adjust the virtual position of the virtual interactor based on the offset, to show a position offset state between the virtual position and the real position.

In some embodiments, the determination unit 230 is configured to: determine a resistance of the virtual object relative to the virtual interactor based on the interaction operation between the real interactor and the virtual object in the virtual reality environment; and determine the offset between the virtual position and the real position based on the resistance.

In some embodiments, when determining the resistance of the virtual object relative to the virtual interactor based on the interaction operation between the real interactor and the virtual object in the virtual reality environment, the determination unit 230 may be configured to: obtain a motion direction, a depth, and an acceleration generated when the real interactor performs an interaction operation with the virtual object in the virtual reality environment, the depth being a depth value of the real interactor relative to a virtual surface of the virtual object, and the acceleration being an acceleration of the real interactor moving relative to the virtual object; and determine the resistance of the virtual object relative to the virtual interactor based on the motion direction, the depth, and the acceleration.

In some embodiments, the resistance includes a resistance value and a resistance direction, and when determining the resistance of the virtual object relative to the virtual interactor based on the motion direction, the depth, and the acceleration, the determination unit 230 may be configured to: determine the resistance value of the virtual object relative to the virtual interactor based on the depth and the acceleration, wherein the depth is in a direct proportion to the resistance value, and the acceleration is in a direct proportion to the resistance value; and determine the resistance direction of the virtual object relative to the virtual interactor based on the motion direction of the real interactor, the resistance direction being opposite to the motion direction.

In some embodiments, when determining the resistance value of the virtual object relative to the virtual interactor based on the depth and the acceleration, the determination unit 230 may be further configured to: obtain a physical characteristic parameter of the virtual object, the physical characteristic parameter including at least one of a mass, a material hardness, and a volume; and determine the resistance value of the virtual object relative to the virtual interactor based on the physical characteristic parameter of the virtual object, the depth, and the acceleration, a parameter value of the physical characteristic parameter being in a direct proportion to the resistance value.

In some embodiments, the offset comprises a displacement distance and a displacement direction, and when determining the offset between the virtual position and the real position based on the resistance, the determination unit 230 is configured to: determine the displacement distance of the offset based on the resistance value; and determine the displacement direction of the offset based on the motion direction of the real interactor, the motion direction being the same as the displacement direction.

In some embodiments, the adjustment unit 240 is configured to: when the resistance value is less than a first resistance threshold, change the virtual position of the virtual interactor based on the offset and a position change of the real interactor; and when the resistance value is greater than or equal to the first resistance threshold, control the virtual position of the virtual interactor to remain unchanged in the virtual reality environment.

In some embodiments, the offset further comprises a posture offset amplitude and a posture offset direction, and when determining the offset between the virtual position and the real position based on the resistance, the determination unit 230 may be configured to: determine the posture offset amplitude of the offset based on the resistance value; and determine the posture offset direction of the offset based on the resistance direction, the resistance direction being the same as the posture offset direction.

In some embodiments, when determining the posture offset amplitude of the offset based on the resistance value, the determination unit 230 may be configured to: when the resistance value is less than a second resistance threshold, determine the posture offset amplitude of the offset based on the resistance value, the resistance value being in a direct proportion to the posture offset amplitude; and when the resistance value is greater than or equal to the second resistance threshold, determine, based on the second resistance threshold, the posture offset amplitude of the offset to remain unchanged.

In some embodiments, the determination unit 230 is further configured to determine a color attribute parameter of the virtual interactor based on the resistance, the color attribute parameter comprising at least one of a hue, a saturation, and a lightness; and the adjustment unit 240 is further configured to adjust a display color of the virtual interactor based on the color attribute parameter when the virtual position of the virtual interactor is adjusted based on the offset.

All the foregoing units in the interaction apparatus 200 may be implemented completely or partially by software, hardware, or a combination thereof. The foregoing units may be embedded in or independent of a processor in a terminal device in a form of hardware, or may be stored in a memory in the terminal device in a form of software, so that the processor can call and execute operations corresponding to the foregoing units.

The interaction apparatus 200 may be integrated into a terminal or a server that includes a memory and is installed with a processor and that has an operation capability, or the interaction apparatus 200 is the terminal or the server.

In some embodiments, the present application further provides a terminal device. The terminal device includes a memory and a processor, the memory stores a computer program, and the processor, when executing the computer program, can implement the steps in the foregoing method embodiments.

As shown in FIG. 14, FIG. 14 is a schematic structural diagram of a terminal device according to an embodiment of the present application. The terminal device 300 may usually be provided in a form of glasses, a head mount display (HMD), or contact lenses, to implement visual perception and another form of perception. Certainly, the form of the terminal device is not limited thereto, and the terminal device may be further miniaturized or enlarged as required. The terminal device 300 may include, but not limited to, the following components:

A detection module 301: detects an operation command from a user by using various sensors, and applies the operation command to a virtual environment, for example, updates an image displayed on a display screen as the user's sight changes, to implement interaction between the user and a virtual scene. For example, the display content is continuously updated based on a detected rotation direction of the user's head.

A feedback module 302: receives data from the sensor, and provides real-time feedback to the user. The feedback module 302 may display a graphical user interface, for example, display a virtual environment on the graphical user interface. For example, the feedback module 302 may include a display screen and the like.

A sensor 303: on the one hand, receives an operation command from the user and applies the operation command to the virtual environment; and on the other hand, provides a result generated after the operation to the user in various feedback forms.

A control module 304: controls the sensor and various input/output devices, including obtaining data (such as an action and a voice) of the user and outputting perception data, such as an image, vibration, temperature, and sound, to act on the user, the virtual environment, and the real world.

A modeling module 305: constructs a three-dimensional model of the virtual environment, and may further include various feedback mechanisms such as sound and tactile sensation in the three-dimensional model.

In the embodiments of the present application, the virtual scene in the virtual reality environment may be constructed by the modeling module 305, and one or more virtual objects are displayed in the virtual scene; the virtual object is displayed in the virtual reality environment by the feedback module 302; the real position of the real interactor is obtained by the detection module 301 and/or the sensor, and the real interactor is mapped to the virtual reality environment by the modeling module 305 to form the virtual interactor; the offset between the virtual position and the real position is determined by the control module 304 based on an interaction operation between the real interactor and the virtual object in the virtual reality environment, the virtual position of the virtual interactor is adjusted based on the offset, and a position offset state between the virtual position and the real position is shown by the feedback module 302.

In some embodiments, as shown in FIG. 15, FIG. 15 is another schematic structural diagram of a terminal device according to an embodiment of the present application. The terminal device 300 further includes a processor 310 with one or more processing cores, a memory 320 with one or more computer-readable storage media, and a computer program stored in the memory 320 and executable on the processor. The processor 310 is electrically connected to the memory 320. A person skilled in the art may understand that the structure of the terminal device shown in the figure does not constitute a limitation on the terminal device, and the terminal device may include more or fewer components than those shown in the figure, or combine some components, or have a different component arrangement.

The processor 310 is a control center of the terminal device 300. The processor 310 connects all parts of the entire terminal device 300 by using various interfaces and lines, and executes various functions of the terminal device 300 and processes data by running or loading a software program and/or a module stored in the memory 320, and calling data stored in the memory 320, thereby monitoring the terminal device 300 as a whole.

In the embodiments of the present application, the processor 310 of the terminal device 300 loads an instruction corresponding to a process of one or more applications into the memory 320 and runs the applications stored in the memory 320 to implement various functions, according to the following steps:
displaying a virtual object in a virtual reality environment; mapping a real interactor to the virtual reality environment based on a real position of the real interactor to form a virtual interactor; determining an offset between a virtual position and the real position based on an interaction operation between the real interactor and the virtual object in the virtual reality environment; and adjusting the virtual position of the virtual interactor based on the offset, to show a position offset state between the virtual position and the real position.

For a specific implementation of each of the foregoing operations, refer to the foregoing embodiments, and details are not described herein again.

In some embodiments, the processor 310 may include the detection module 301, the control module 304, and the modeling module 305.

In some embodiments, as shown in FIG. 15, the terminal device 300 further includes a radio frequency circuit 306, an audio circuit 307, and a power supply 308. The processor 310 is electrically connected to the memory 320, the feedback module 302, the sensor 303, the radio frequency circuit 306, the audio circuit 307, and the power supply 308. A person skilled in the art may understand that the structure of the terminal device shown in FIG. 14 or FIG. 15 does not constitute a limitation on the terminal device, and the terminal device may include more or fewer components than those shown in the figure, or combine some components, or have a different component arrangement.

The radio frequency circuit 306 may be configured to receive and transmit radio frequency signals, to establish wireless communication with a network device or another terminal device through wireless communication, and to receive and transmit signals between the network device or the other terminal device.

The audio circuit 307 may be configured to provide an audio interface between a user and the terminal device through a speaker and a microphone. The audio circuit 307 may convert an electrical signal obtained after received audio data is converted, and transmit the electrical signal to the speaker, and the speaker converts the electrical signal into a sound signal for output; on the other hand, the microphone converts a collected sound signal into an electrical signal, the audio circuit 307 receives the electrical signal and converts the electrical signal into audio data, and then outputs the audio data to the processor 310 for processing, and the radio frequency circuit 306 transmits the audio data to, for example, another terminal device, or outputs the audio data to the memory for further processing. The audio circuit 307 may further include an earphone jack, to provide communication between an external earphone and the terminal device.

The power supply 308 is configured to supply power to all components of the terminal device 300.

Although not shown in FIG. 14 or FIG. 15, the terminal device 300 may further include a camera, a Wi-Fi module, a Bluetooth module, an input module, and the like, which are not described herein again.

In some embodiments, this application further provides a computer-readable storage medium, configured to store a computer program. The computer-readable storage medium may be applied to a terminal device or a server, and the computer program enables the terminal device or the server to perform a corresponding procedure in the interaction method in the embodiments of this application. For the sake of brevity, details are not described herein again.

In some embodiments, this application further provides a computer program product. The computer program product includes a computer program, and the computer program is stored in a computer-readable storage medium. A processor of a terminal device reads the computer program from the computer-readable storage medium, and the processor executes the computer program, so that the terminal device performs a corresponding procedure in the interaction method in the embodiments of this application. For the sake of brevity, details are not described herein again.

This application further provides a computer program. The computer program includes a computer program, and the computer program is stored in a computer-readable storage medium. A processor of a terminal device reads the computer program from the computer-readable storage medium, and the processor executes the computer program, so that the terminal device performs a corresponding procedure in the interaction method in the embodiments of this application. For the sake of brevity, details are not described herein again.

It should be understood that a processor in the embodiments of this application may be an integrated circuit chip, and has a signal processing capability. In the implementation process, each step of the foregoing method embodiments may be completed by an integrated logic circuit of hardware in the processor or an instruction in a form of software. The foregoing processor may be a general-purpose processor, a digital signal processor (Digital Signal Processor, DSP), an application-specific integrated circuit (Application Specific Integrated Circuit, ASIC), a ready-made programmable gate array (Field Programmable Gate Array, FPGA) or another programmable logic device, a discrete gate or transistor logic device, or a discrete hardware component. Each method, step, and logic block diagram disclosed in the embodiments of this application may be implemented or performed. The general-purpose processor may be a microprocessor, or the processor may be any conventional processor, or the like. The steps of the method disclosed in combination with the embodiments of this application may be directly embodied as being executed and completed by a hardware decoding processor, or may be completed by a combination of hardware and software modules in the decoding processor. The software module may be located in a mature storage medium in the art, such as a random-access memory, a flash memory, a read-only memory, a programmable read-only memory, an electrically erasable programmable memory, or a register. The storage medium is located in a memory, and a processor reads information in the memory and completes the steps of the foregoing method in combination with the hardware.

It may be understood that a memory in the embodiments of this application may be a volatile memory or a non-volatile memory, or may include both the volatile memory and the non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random-access memory (Random Access Memory, RAM), which is used as an external cache. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). It should be noted that the memory in the systems and methods described in this specification is intended to include, but is not limited to, these and any other suitable types of memories.

A person of ordinary skill in the art may be aware that units and algorithm steps of examples described with reference to the embodiments disclosed herein may be implemented by electronic hardware or a combination of computer software and electronic hardware. Whether the functions are performed by hardware or software depends on a specific application and design constraint conditions of a technical solution. A person skilled in the art may implement the described functions for each specific application by using different methods, but it should not be considered that the implementation goes beyond the scope of this application.

A person skilled in the art may clearly understand that, for the convenience and brevity of description, for a specific working process of the system, the apparatus, and the unit described above, reference may be made to corresponding processes in the foregoing method embodiments, and details are not described herein again.

In the embodiments of this application, the term “module” or “unit” refers to a computer program or a part of the computer program that has a predetermined function, and works with other related parts to achieve a predetermined goal, and may be implemented in whole or in part by using software, hardware (such as a processing circuit or a memory), or a combination thereof. Similarly, one processor (or a plurality of processors or memories) may be used to implement one or more modules or units. In addition, each module or unit may be a part of an overall module or unit that includes the functions of the module or unit.

In several embodiments provided in this application, it should be understood that the disclosed system, apparatus, and method may be implemented in other manners. For example, the described apparatus embodiments are merely examples. For example, the division of the units is merely logical function division, and there may be another division manner in actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electrical, mechanical, or other forms.

The units described as separate parts may be or may not be physically separate, and parts displayed as units may be or may not be physical units, and may be located at one position, or may be distributed on a plurality of network units. Some or all of the units may be selected according to actual needs to achieve the objectives of the solutions of the embodiments.

In addition, all the functional units in the embodiments of this application may be integrated into one processing unit, each of the units may exist alone physically, or two or more units may be integrated into one unit. If the functions are implemented in the form of a software functional unit and sold or used as an independent product, the functions may be stored in a computer-readable storage medium. Based on such an understanding, the technical solutions of this application are essentially, or the part contributing to the prior art, or the part of the technical solutions may be embodied in the form of a software product, and the computer software product is stored in a storage medium, where the storage medium includes several instructions for instructing a terminal device (which may be a personal computer or a server) to perform all or some of the steps of the methods described in the embodiments of this application. The foregoing storage medium includes: any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An interaction method, wherein, the method comprises:
displaying a virtual object in a virtual reality environment;
mapping a real interactor to the virtual reality environment to form a virtual interactor, based on a real position of the real interactor;
determining an offset between a virtual position and the real position based on an interaction operation between the real interactor and the virtual object in the virtual reality environment; and
adjusting the virtual position of the virtual interactor based on the offset to show a position offset state between the virtual position and the real position.

2. The interaction method according to claim 1, wherein the determining an offset between a virtual position and a real position based on an interaction operation between the real interactor and the virtual object in the virtual reality environment comprises:
determining, based on the interaction operation between the real interactor and the virtual object in the virtual reality environment, a resistance of the virtual object relative to the virtual interactor; and
determining the offset between the virtual position and the real position based on the resistance.

3. The interaction method according to claim 2, wherein the determining, based on the interaction operation between the real interactor and the virtual object in the virtual reality environment, a resistance of the virtual object relative to the virtual interactor comprises:
obtaining a motion direction, a depth, and an acceleration that are generated when the real interactor performs an interaction operation with the virtual object in the virtual reality environment, the depth being a depth value of the real interactor relative to a virtual surface of the virtual object, and the acceleration being an acceleration of the real interactor moving relative to the virtual object; and
determining the resistance of the virtual object relative to the virtual interactor based on the motion direction, the depth, and the acceleration.

4. The interaction method according to claim 3, wherein the resistance comprises a resistance value and a resistance direction, and the determining the resistance of the virtual object relative to the virtual interactor based on the motion direction, the depth, and the acceleration comprises:
determining the resistance value of the virtual object relative to the virtual interactor based on the depth and the acceleration, wherein the depth is in a direct proportion to the resistance value, and the acceleration is in a direct proportion to the resistance value; and
determining the resistance direction of the virtual object relative to the virtual interactor based on the motion direction of the real interactor, the resistance direction being opposite to the motion direction.

5. The interaction method according to claim 3, wherein the determining the resistance value of the virtual object relative to the virtual interactor based on the depth and the acceleration further comprises:
obtaining a physical characteristic parameter of the virtual object, the physical characteristic parameter comprising at least one of mass, material hardness, and volume; and
determining the resistance value of the virtual object relative to the virtual interactor based on the physical characteristic parameter of the virtual object, the depth, and the acceleration, a parameter value of the physical characteristic parameter being in a direct proportion to the resistance value.

6. The interaction method according to claim 4, wherein the offset comprises a displacement distance and a displacement direction, and the determining the offset between the virtual position and the real position based on the resistance comprises:
determining the displacement distance of the offset based on the resistance value, the resistance value being in a direct proportion to the displacement distance; and
determining the displacement direction of the offset based on the motion direction of the real interactor, the motion direction being the same as the displacement direction.

7. The interaction method according to claim 6, wherein the adjusting the virtual position of the virtual interactor based on the offset comprises:
when the resistance value is less than a first resistance threshold, changing the virtual position of the virtual interactor based on the offset and a position change of the real interactor; or
when the resistance value is greater than or equal to the first resistance threshold, controlling the virtual position of the virtual interactor to remain unchanged in the virtual reality environment.

8. The interaction method according to claim 4, wherein the offset further comprises a posture offset amplitude and a posture offset direction, and the determining the offset between the virtual position and the real position based on the resistance comprises:
determining the posture offset amplitude of the offset based on the resistance value; and
determining the posture offset direction of the offset based on the resistance direction, the resistance direction being the same as the posture offset direction.

9. The interaction method according to claim 8, wherein the determining the posture offset amplitude of the offset based on the resistance value comprises:
when the resistance value is less than a second resistance threshold, determining the posture offset amplitude of the offset based on the resistance value, the resistance value being in a direct proportion to the posture offset amplitude; or
when the resistance value is greater than or equal to the second resistance threshold, determining that the posture offset amplitude of the offset remains unchanged based on the second resistance threshold.

10. The interaction method according to claim 2, wherein the method further comprises:
determining a color attribute parameter of the virtual interactor based on the resistance, the color attribute parameter comprising at least one of hue, saturation, and lightness; and
when the virtual position of the virtual interactor is adjusted based on the offset, adjusting a display color of the virtual interactor based on the color attribute parameter.

11. A non-transitory computer-readable storage medium, wherein the computer-readable storage medium stores a computer program, the computer program being adapted to be loaded by a processor to execute:
displaying a virtual object in a virtual reality environment;
mapping a real interactor to the virtual reality environment to form a virtual interactor, based on a real position of the real interactor;
determining an offset between a virtual position and the real position based on an interaction operation between the real interactor and the virtual object in the virtual reality environment; and
adjusting the virtual position of the virtual interactor based on the offset to show a position offset state between the virtual position and the real position.

12. The non-transitory computer-readable storage medium according to claim 11, wherein the determining an offset between a virtual position and a real position based on an interaction operation between the real interactor and the virtual object in the virtual reality environment comprises:
determining, based on the interaction operation between the real interactor and the virtual object in the virtual reality environment, a resistance of the virtual object relative to the virtual interactor; and
determining the offset between the virtual position and the real position based on the resistance.

13. The non-transitory computer-readable storage medium according to claim 12, wherein the determining, based on the interaction operation between the real interactor and the virtual object in the virtual reality environment, a resistance of the virtual object relative to the virtual interactor comprises:
obtaining a motion direction, a depth, and an acceleration that are generated when the real interactor performs an interaction operation with the virtual object in the virtual reality environment, the depth being a depth value of the real interactor relative to a virtual surface of the virtual object, and the acceleration being an acceleration of the real interactor moving relative to the virtual object; and
determining the resistance of the virtual object relative to the virtual interactor based on the motion direction, the depth, and the acceleration.

14. The non-transitory computer-readable storage medium according to claim 12, wherein the offset comprises a displacement distance and a displacement direction, and the determining the offset between the virtual position and the real position based on the resistance comprises:
determining the displacement distance of the offset based on the resistance value, the resistance value being in a direct proportion to the displacement distance; and
determining the displacement direction of the offset based on the motion direction of the real interactor, the motion direction being the same as the displacement direction, and/or
wherein the offset further comprises a posture offset amplitude and a posture offset direction, and the determining the offset between the virtual position and the real position based on the resistance comprises:
determining the posture offset amplitude of the offset based on the resistance value; and
determining the posture offset direction of the offset based on the resistance direction, the resistance direction being the same as the posture offset direction.

15. The non-transitory computer-readable storage medium according to claim 12, the computer program being further adapted to be loaded by the processor to execute:
determining a color attribute parameter of the virtual interactor based on the resistance, the color attribute parameter comprising at least one of hue, saturation, and lightness; and
when the virtual position of the virtual interactor is adjusted based on the offset, adjusting a display color of the virtual interactor based on the color attribute parameter.

16. A terminal device, wherein the terminal device comprises a processor and a memory, the memory storing a computer program, and the processor is configured to call the computer program stored in the memory to execute:
displaying a virtual object in a virtual reality environment;
mapping a real interactor to the virtual reality environment to form a virtual interactor, based on a real position of the real interactor;
determining an offset between a virtual position and the real position based on an interaction operation between the real interactor and the virtual object in the virtual reality environment; and
adjusting the virtual position of the virtual interactor based on the offset to show a position offset state between the virtual position and the real position.

17. The terminal device according to claim 16, wherein the determining an offset between a virtual position and a real position based on an interaction operation between the real interactor and the virtual object in the virtual reality environment comprises:
determining, based on the interaction operation between the real interactor and the virtual object in the virtual reality environment, a resistance of the virtual object relative to the virtual interactor; and
determining the offset between the virtual position and the real position based on the resistance.

18. The terminal device according to claim 17, wherein the determining, based on the interaction operation between the real interactor and the virtual object in the virtual reality environment, a resistance of the virtual object relative to the virtual interactor comprises:
obtaining a motion direction, a depth, and an acceleration that are generated when the real interactor performs an interaction operation with the virtual object in the virtual reality environment, the depth being a depth value of the real interactor relative to a virtual surface of the virtual object, and the acceleration being an acceleration of the real interactor moving relative to the virtual object; and
determining the resistance of the virtual object relative to the virtual interactor based on the motion direction, the depth, and the acceleration.

19. The terminal device according to claim 17, wherein the offset comprises a displacement distance and a displacement direction, and the determining the offset between the virtual position and the real position based on the resistance comprises:
determining the displacement distance of the offset based on the resistance value, the resistance value being in a direct proportion to the displacement distance; and
determining the displacement direction of the offset based on the motion direction of the real interactor, the motion direction being the same as the displacement direction, and/or
wherein the offset further comprises a posture offset amplitude and a posture offset direction, and the determining the offset between the virtual position and the real position based on the resistance comprises:
determining the posture offset amplitude of the offset based on the resistance value; and
determining the posture offset direction of the offset based on the resistance direction, the resistance direction being the same as the posture offset direction.

20. The terminal device according to claim 17, wherein the processor is configured to call the computer program stored in the memory to execute:
determining a color attribute parameter of the virtual interactor based on the resistance, the color attribute parameter comprising at least one of hue, saturation, and lightness; and
when the virtual position of the virtual interactor is adjusted based on the offset, adjusting a display color of the virtual interactor based on the color attribute parameter.
